(19) United States
(12) Patent Application Publication
(10) Pub. No.: US 2021/0186036 A1
(43) Pub. Date: Jun. 24, 2021

(54) COVER DEVICE FOR NOODLE-MAKING MACHINE

(71) Applicant: YUTAKA MFG. CO., LTD., Kounan-shi (JP)

(72) Inventors: Masayasu KURACHI, Kounan-shi (JP); Atsushi TAKAHARA, Kounan-shi (JP)

(73) Assignee: YUTAKA MFG. CO., LTD., Kounan-shi (JP)

(21) Appl. No.: 17/113,217

(22) Filed: Dec. 7, 2020

(30) Foreign Application Priority Data
Dec. 24, 2019 (JP) 2019-232407

(51) Int. Cl. A21C 11/22; B26D 7/22

(52) U.S. Cl. CPC A21C 11/22; B26D 7/225

(57) ABSTRACT

A cover device of a noodle-making machine comprises a covering member, a hinge member, and a stopper. The covering member is configured to cover an opening where a cutting blade can be exchanged therethrough. The stopper prevents the closed covering member from opening. The stopper is configured to move between a locked position and an unlocked position. When the stopper is at the unlocked position, the covering member can be opened. The stopper is configured to rotate from the unlocked position to the locked position due to gravity, without user intervention, when the covering member is at the closed position. The stopper is held by the hinge member when the covering member is at the open position.

### CROSS-REFERENCE TO RELATED APPLICATIONS

This application claims priority to Japanese patent application serial number 2019-232407, filed on Dec. 24, 2019, the contents of which are incorporated herein by reference for all purposes.

### STATEMENT REGARDING FEDERALLY SPONSORED RESEARCH OR DEVELOPMENT

Not applicable.

### BACKGROUND

The present disclosure relates to a cover device to cover an opening of a noodle-making machine.

A noodle-making machine for making noodles, such as udon noodles or soba noodles, has a cutting blade to shred a noodle band supplied from a continuous rolling mill. The shredded noodles are evenly cut into an appropriate length by a cutter provided in the noodle-making machine. The noodle-making machine has an opening in front of the cutter. The opening can be covered by a cover in order to prevent foreign matter from entering into the cutter through the opening. In this case, the cover is fixed by nuts and bolts at a position to cover the opening. However, the cutting blade needs to be changed depending on the kind of noodles being cut. Thus, there often is no cover to cover an opening in front of the cutting blade. Japanese Utility model Application publication No. 7-18585 discloses a device allowing for efficient exchange of cutting blades.

If a cover is provided in front of the cutting blade, so as to cover the opening, the cover needs to be opened and closed every time the cutting blade is exchanged. This can decrease the productivity of manufacturing noodles. To combat this problem, an improved cover device is needed.

### BRIEF SUMMARY

A cover device of a noodle-making machine may comprise a covering member, a hinge member, and a stopper. The covering member is configured to cover an opening where a cutting blade used for cutting a noodle band can be exchanged therethrough. The hinge member is configured to support the covering member so that the covering member may be moved between an open position, where the opening is exposed, and a closed position, where the opening is covered. When the covering member is positioned at the closed position, the stopper prevents the covering member from moving to the open position. The stopper is provided at a first surface of the covering member, the first surface being on a side opposite to a second surface of the covering member, the second surface being configured to face the opening. When the covering member is at the closed position, the stopper is configure to extend across a covering member side portion of the hinge member and a housing side portion of the hinge member. A hinge shaft of the hinge member is positioned between the covering member side portion and the housing side portion. The stopper is configured to move between a lock position and an unlock position along either the covering member side portion or the housing side portion. When the stopper is at the lock position, the stopper is configured to prevent the covering member from moving from the closed position to the open position. When the stopper is at the unlock position, the stopper allows the covering member to be moved from the closed position to the open position. The stopper is biased so that the stopper moves from the unlock position to the lock position without operation by a user when the covering member is at the closed position. The stopper is held between the covering member side portion and the housing side portion of the hinge member when the covering member is at the open position.

In a first aspect of the present disclosure, the hinge shaft of the hinge member may be disposed at edge portions of the covering member, so that the hinge shaft extend in a horizontal, vertical, or oblique direction. When the covering member is at the open position, at least the cutting blade can be replaced through the opening. Thus, the open position of the covering member can be appropriately determined. The hinge shaft may be placed between the covering member side portion and the housing side portion of the hinge member. The stopper may be provided on either the covering member side portion or the housing side portion. The stopper may move between the lock position and the unlock position by rotating around the hinge shaft. Alternatively, the stopper may move between the lock position and the unlock position by sliding along a slide wire.

According to the first aspect of the present disclosure, when opening the covering member, the stopper can be moved from the locked position to the unlocked position by only a one-touch operation. When closing the covering member, the stopper can automatically move from the unlock position to the lock position due to the biasing force. Thus, the covering member can be automatically locked. Therefore, the opening operation of the covering member can be easy, as compared to removing bolts and nuts. As a result, even if the covering member is provided to cover an opening at a position in front of the replaceable cutting blades, the manufacturing productivity of noodles can be maintained.

### BRIEF DESCRIPTION OF THE DRAWINGS

FIG. 1 is a side view of a noodle production apparatus. The noodle production apparatus has a noodle-making machine where a covering device of an embodiment is applied.

FIG. 2 is an enlarged side view of the above-mentioned noodle making machine.

FIG. 3 is a partial enlarged front view of the above-mentioned noodle making machine.

FIG. 4 is a sectional view taken along line IV-IV in FIG. 2.

FIG. 5 is a partial enlarged perspective view of the above-mentioned noodle making machine.

FIG. 6 is a perspective view similar to FIG. 5 and illustrates a cover in an open position.

### DETAILED DESCRIPTION

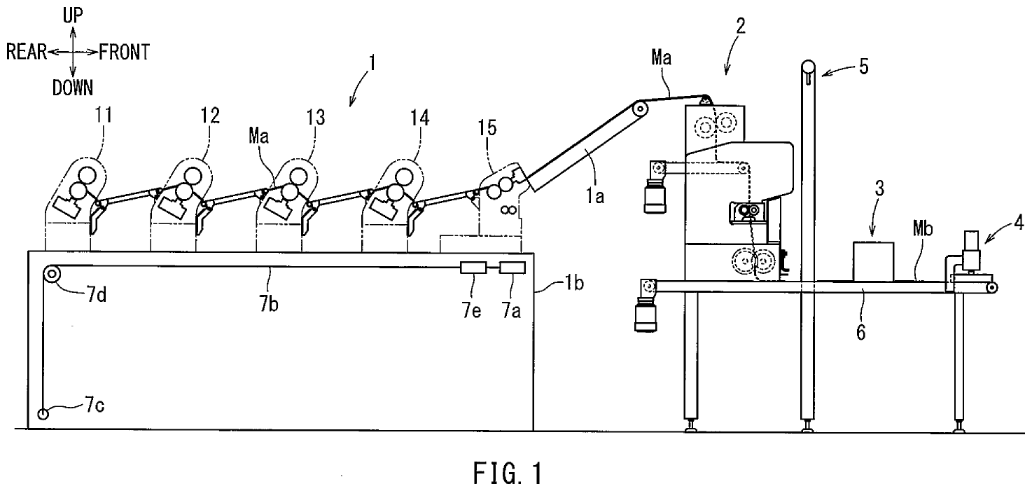

FIG. 1 illustrates a noodle production apparatus disposed on a floor. In FIG. 1, a front direction is defined as a direction in which noodles manufactured by the noodle production apparatus are conveyed out. The directions are shown by arrows as indicated in FIG. 1. The same is true of the other Figures.

The noodle production apparatus has a continuous rolling mill 1 and a noodle-making machine 2. The continuous rolling mill 1 can be used to gradually reduce the thickness of a noodle band Ma, for instance by sequentially passing the noodle band Ma through rolling mills 11 to 15. In this way, the thickness of the noodle band Ma can be adjusted to the desired thickness. A noodle band Ma may be supplied from the continuous rolling mill 1 to a first conveyor 1a. The noodle band Ma is then cut into noodles Mb by the noodle-making machine 2. These noodles Mb may be evenly cut to an appropriate length. Then, the noodles Mb may be transferred by a second conveyor 6. A powder spraying machine 3 may be provided at the second conveyor 6. The powder spraying machine 3 may be used to spray powder on the noodles Mb, so as to prevent the noodles Mb from sticking to each other. Aligning rollers 4 may be provided at a downstream end of the second conveyor 6. The noodles Mb may be gathered in a central portion of the second conveyor 6 by the width aligning roller 4. The noodles Mb may then be bundled for shipment. A tower crane 5 may be provided adjacent the noodle-making machine 2. The tower crane 5 may be used to lift and move cutting blades disposed in the noodle-making machine 2, for instance when the cutting blades are being exchanged.

The continuous rolling mill 1 may have rolling mills 11 to 15 fixed on a stand 1b. A cord-like body 7b is disposed along a side surface of the stand 1b. A predetermined tension is applied to the cord-like body 7b. Specifically, the cord-like body 7b may be made of a metal wire. The cord-like body 7b may be disposed near an upper surface of the stand 1b, so as to extend in the horizontal direction. There may be a distance of about 10 cm to 20 cm between the cord-like body 7b and the side surface of the stand 1b. The rear end portion of the cord-like body 7b may extend in the vertical direction, via a pulley 7d. A lower end portion of the cord-like body 7b may be fixed to a ring-shaped connecting member 7c. The connecting member 7c may be disposed adjacent to a lower end portion of the stand 1b. A forward end portion of the cord-like body 7b may be fixed to the stand 1b, via a tension spring 7e and a limit switch 7a. The limit switch 7a may be configured to detect whether the tension applied to the cord-like body 7b is greater than a predetermined value. The tension spring 7e may be configured to apply a predetermined tension to the cord-like body 7b.

The limit switch 7a may be electrically connected to a control circuit (not shown) of the continuous rolling mill 1. The control circuit is configured to forcibly stop operation of the continuous rolling mill 1, for instance when the limit switch 7a detects the tension of the cord-like body 7b is greater than a predetermined value.

When an operator approaches the stand 1b and touches the cord-like body 7b, the tension of the cord-like body 7b may increase. If the limit switch 7a detects such condition, the control circuit can stop the operation of the continuous rolling mill 1. This can prevent an operator from accidentally touching the continuous rolling mill 1. In this embodiment, as described above, the cord-like body 7b may be disposed near the upper surface of the stand 1b, so as to extend in the horizontal direction. Additionally, a portion of the cord-like body 7b may be disposed at the rear portion of the stand 1b, so as to extend in the vertical direction. In this way, the limit switch 7a may have a detection area that extends over substantially the entire area of the stand 1b, especially in the horizontal direction. Additionally, the detection area extends over substantially the entire area of the rear portion of the continuous rolling mill 1, especially in the vertical direction. In this way, the detection area of the limit switch 7a can be appropriately set, depending on the disposing position of the cord-like body 7b.

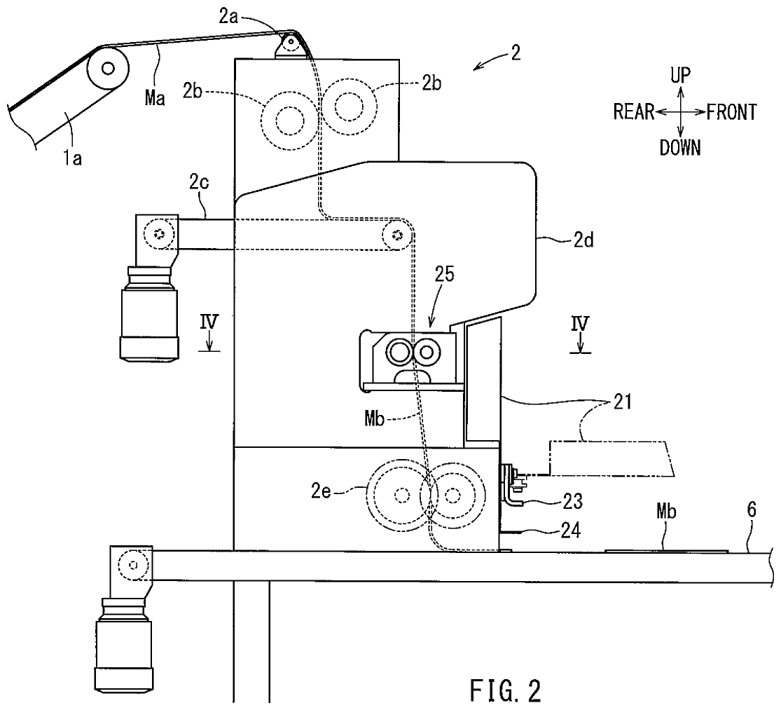

FIG. 2 illustrates an enlarged view of the noodle-making machine 2. The noodle-making machine 2 has cutting blades 25 and cutters 2e in a housing 2d. The cutting blades 25 may be placed in a central space of the housing 2d. The noodle band Ma may be supplied from the conveyor 1a of the continuous rolling mill 1 via rollers 2a, 2b and a conveyor 2c. The noodle band Ma may be cut into noodles Mb by the cutting blades 25. The cutters 2e may be disposed below the cutting blades 25 and may be configured to evenly cut the noodles Mb into an appropriate length.

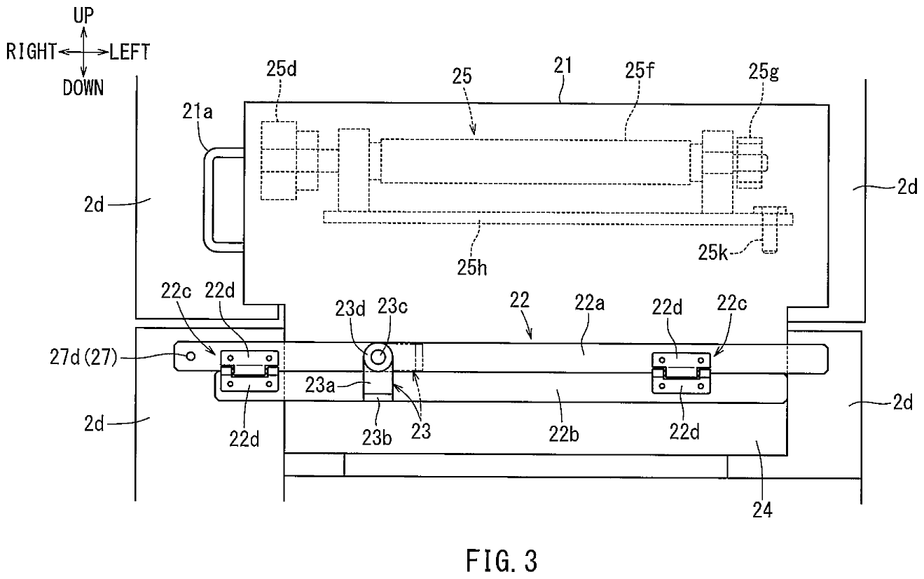

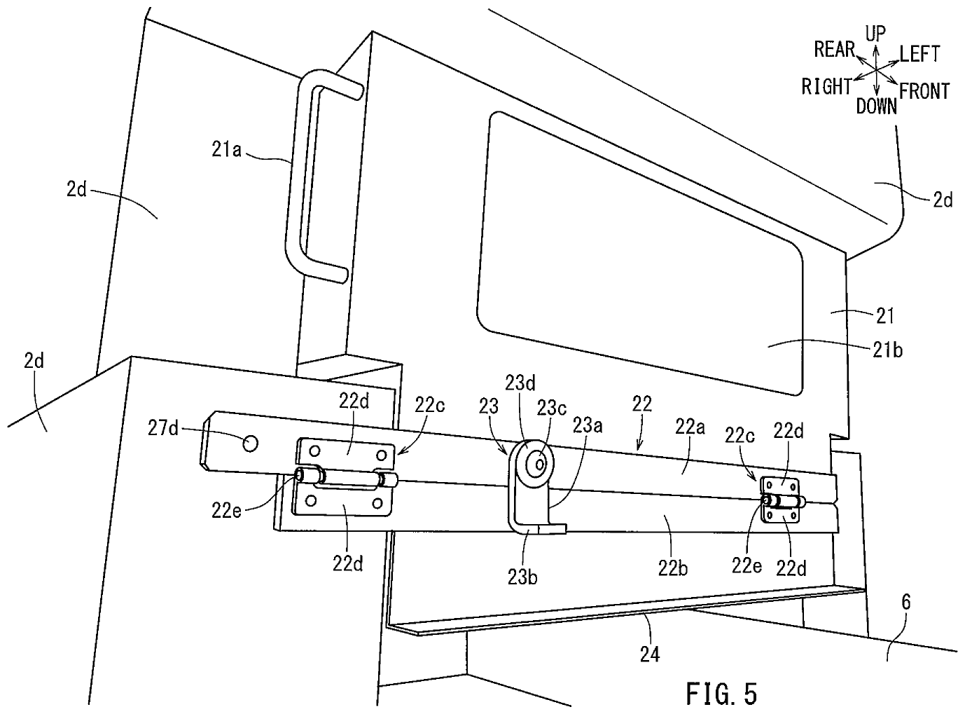

The conveyor 6 may be positioned under the cutters 2e. The conveyor 6 may be used to transfer the noodles Mb, after they have been evenly cut by the cutters 2e. In front of the cutting blades 25, an opening of the housing 2d (e.g., see FIG. 3) is provided. The opening may be openably covered by a first covering member 21. Additionally, there is another opening of the housing in front of the cutters 2e (e.g., see FIGS. 2 and 5). A second covering member 24 may be fixed to the housing 2d by bolts (not shown).

FIGS. 3 to 6 illustrate a cover device mainly composed of the first covering member 21, in an enlarged view. The first covering member 21 may be comprised of stainless steel and may be configured to be openable in a vertical direction about a lower hinge member. The first covering member 21 may have a hinge member 22 provided at a lower edge portion of the first covering member 21. The hinge member 22 may have a belt-shaped first hinge frame 22a, a belt-shaped second hinge frame 22b, and a pair of hinge bodies 22c connecting the first hinge frame 22a to the second hinge frame 22b. The first hinge frame 22a may be fixed to the lower edge portion of the first covering member 21. The first hinge frame 22a corresponds to a covering member side portion of the present disclosure. The second hinge frame 22b may be disposed along a lower part of the first hinge frame 22a and may be fixed to the housing 2d. The second hinge frame 22b corresponds to a housing side portion of the present disclosure. Each hinge body 22c may have two attaching pieces 22d configured to relatively rotate around a hinge shaft 22e. The upper attaching piece 22d may be fixed to the first hinge frame 22a. The lower attaching piece 22d may be fixed to the second hinge frame 22b. In this configuration, the hinge bodies 22c may be free stop hinges (e.g., torque hinges). When an opening or closing operation of the first covering member 21 is not performed, the attaching pieces 22d may be held at a given orientation, primarily due to a frictional force. In this way, the first covering member 21 can be prevented from accidentally being opened due to gravity.

The first covering member 21 may have a window 21b comprised of a light-transmissive material. The window 21b may be embedded in the first covering member 21. Thus, an operator can observe the cutting blades 25 through the window 21b, even if the first covering member 21 is closed. Further, the first covering member 21 may have a handle 21a on its right side surface. Thus, an operator can easily open or close the first covering member 21 by using the handle 21a.

The first hinge frame 22a may have a stopper 23. The stopper 23 may be an L-shaped angle member, formed, for instance, by bending a stainless plate. The stopper 23a may have a first part 23a and a second part 23b. The first part 23a may be affixed to the first hinge frame 22a, via a bushing 23d, by a screw 23c. The first part 23a may be configured to rotate along a front surface of the first hinge frame 22a. The second part 23b may be configured to project forward from the first part 23a.

The first part 23a may have a longitudinal length sufficient enough to extend over and cover the first and second hinge frames 22a, 22b in vertical direction. The longitudinal length of the second part 23b may be half of that of the first part 23a. The first part 23a and the second part 23b may have substantially the same widths, or slightly small widths, compared to the longitudinal lengths of the first and second hinge frames 22a, 22b. Thus, when the first covering member 21 is closed, as is illustrated in FIGS. 3 and 5, the second part 23b of the stopper 23a may be positioned at a lower side of the stopper 23 (in a gravity direction). When the second part 23b is positioned at the lower side of the stopper 23a, the stopper 23 can prevent the first hinge frame 22a from being inclined forward. In this way, the stopper 23 can be placed in a locked position.

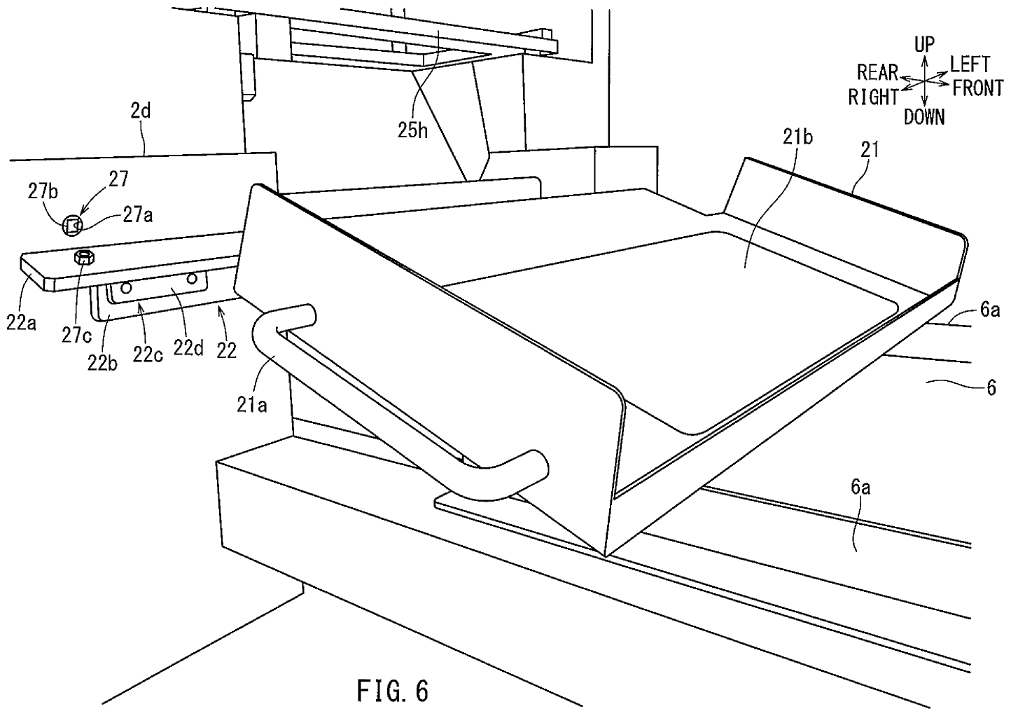

In order to open the first covering member 21, as is shown in FIG. 6, the stopper 23 can be rotated to an unlocked position, in which the first part 23a extends parallel to the longitudinal direction of the first hinge frame 22a, as shown by an imaginary line in FIG. 3. When the first covering member 21 is opened, the stopper 23 may be placed between the first hinge frame 22a and second hinge frame 22b, which are now in a position approaching each other. As a result of the first covering member 21 being in the opened position, the stopper 23 may be prevented from fully rotating back to the closed position, thereby causing the stopper 23 to be held at the unlock position. Thus, once the stopper has been moved to the unlock position, the stopper 23 can be held at the unlock position while the first covering member 21 is in the opened position.

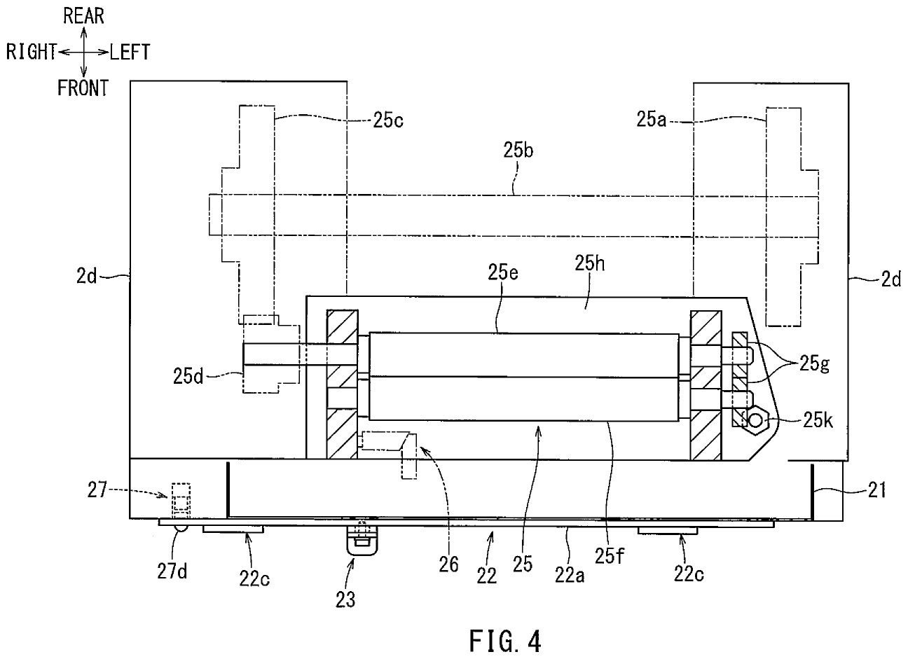

The housing 2d may have a covering member detection switch 27. When the first covering member 21 is in the closed position, as illustrated in FIGS. 3 and 5, the covering member detection switch 27 may be covered by the first hinge frame 22a. When the first covering member 21 is in the opened position, as illustrated in FIG. 6, the covering member detection switch 27 may be exposed. As illustrated in FIGS. 4 and 6, the covering member detection switch 27 may be comprised of a limit switch 27b embedded in a mounting hole 27a formed in the housing 2d. The first hinge frame 22a may have a bolt 27c, fixed by a nut 27d, at a portion where it may face the limit switch 27b. Thus, when the first covering member 21 is in the closed position, the limit switch 27b of the covering member detection switch 27 may be actuated by the bolt 27c. When the first covering member 21 is in the opened position, the limit switch 27b is not actuated by the bolt 27c. In this way, the covering member detection switch 27 can detect whether the first covering member 21 is in the opened position or in a position other than the closed position.

As illustrated in FIGS. 2, 3 and 5, a second covering member 24 may be provided below the first covering member 21. The second covering member 24 is configured to cover an opening of the housing 2d, for instance an opening in the housing 2d that faces the cutters 2e. The second covering member 24 may be fixed to the housing 2d by one or more bolts (not shown). Generally, it is unnecessary to replace the cutters 2e very often, especially as compared to the cutting blades 25. Thus, it is unnecessary to open and close the second covering member 24 often. Accordingly, even if the second covering member 24 is fixed to the housing 2d by bolts, such a configuration does not significantly affect the noodle production productivity. In some embodiments, the second covering member 24 can be structured to be opened and closed, like the first covering member 21, if needed.

As illustrated in FIGS. 3 and 4, the cutting blades 25 may be detachably fixed to a blade holder 25h, in such a way that it may be easily replaced. The blade holder 25h may have a flame shape. The blade holder 25h may be supported by a hinge pin 25k, so that the blade holder 25h can rotate in the horizontal direction in the housing 2d. The hinge pin 25k may be positioned at the left side in the opening of the housing 2d. The cutting blade 25 includes first and second blades 25e, 25f, a connection gear 25g, and a reduction gear 25d. These components may be integrally assembled. The cutting blade 25 may be detachable from the blade holder 25h. Thus, when the cutting blade 25 is to be replaced, the first covering member 21 may be opened. The blade holder 25h may then be rotated in the horizontal direction around the hinge pin 25k. In this way, the cutting blade 25 can be more easily replaced through the opening. For instance, the cutting blade 25 can be held in a state where the cutting blade 25 and the blade holder 25h are locate outside of the housing 2d. The blade holder 25h may have an index plunger 26. The index plunger 26 may be located on the right side of the blade holder 25h, away from the hinge pin 25k. The index plunger 26 is configured to secure the blade holder 25h to the housing 2d. In this way, the blade holder 25h can be set at a fixed position within the housing 2d, so as to allow for shredding of the noodle band Ma. When the blade holder 25h and the cutting blade 25 are set at the fixed position, the reduction gear 25d may engage with a driven gear 25c. As a result, the cutting blades 25 can be rotary-driven, via a driving shaft 25b, driven by a driven gear 25a.

When the first covering member 21 is moved from the closed position to the open position, the first part 23a of the stopper 23 may be rotated to a position shown by the imaginary line in FIG. 3. Accordingly, the stopper 23 may be positioned at the unlock position. That is, the first part 23a may be rotated so that the longitudinal direction of the first part 23a extends at least in the horizontal direction, and possibly at least partly in the upward direction. The second part 23b of the stopper 23 is easy to grasp because the second part 23b projects forward from the first part 23a. Thus, the rotational operation of the stopper 23 is easy.

When the stopper 23 is set at the unlocked position, the first covering member 21 can be opened using the handle 21a. At this time, the stopper 23 can be pinched between the first hinge frame 22a and second the hinge frame 22b. For instance, a corner formed between the first and second parts 23a, 23b of the stopper 23 can contact the second hinge frame 22b, so as to prevent undesirable rotation of the stopper 23 about the bushing 23d. As a result, the stopper 23 can be held at the unlocked position. Thus, there is no need for the user to hold the stopper 23 while opening the first covering member 21. Rotation of the first covering member 21 beyond a certain amount may be limited by a bracket 6a of the conveyor 6, as shown in FIG. 6.

When the first covering member 21 has been opened, the covering member detection switch 27 can detect the opening state of the first covering member 21. The covering member detection switch 27 may then send signal(s) to a control circuit (not shown), so as to stop operation of the cutting blade 25 and the cutters 2e. In this way, the cutting blade 25 and the cutters 2e can be prevented from wasteful operation and safety may be improved.

After completion of the exchange of the cutting blades 25, the first covering member 21 may be moved from the open position to the closed position. When performing this movement, the first covering member 21 can be closed solely by using the handle 21a. Since the stopper 23 is held at the unlock position while the first covering member 21 is being closed, the user does not need to touch the stopper 23. Thus, the operation of the stopper 23 is unnecessary while closing the first covering member 21.

When the first covering member 21 is in the closed position, front surfaces of the first hinge frame 22a and the second hinge frame 22b may be positioned on the same plane. Thus, the stopper 23 can be released from being pinched between the first hinge frame 22a and the second hinge frame 22b. As a result, the first part 23a of the stopper 23 can rotate due to gravity. As a result, the first part 23a of the stopper 23 can be positioned so as to extend vertically, as shown by a solid line in FIG. 3. In this way, the stopper 23 can be automatically returned to the locked position, which allows the first covering member 21 to be locked in the closed position. That is, the stopper 23 can be rotated from the unlock position to the lock position due to gravity. Thus, the stopper 23 can be rotated without any other extra energy. Additionally, the stopper 22 can be simply configured.

When the first covering member 21 is closed, the covering member detection switch 27 can detect the closed state of the first covering member 21 and can send signal(s) to the control circuit (not shown), so as to activate the cutting blade 25 and the cutters 2e.

Once an operator rotates the stopper 23 from the locked position to the unlocked position at the beginning of the opening operation of the first covering member 21, the operator can simply open or close the first covering member 21. Thus, a fall in productivity of manufacturing noodles due to the replacement of the cutting blade 25 can be inhibited. Additionally, when the first covering member 21 is returned to the closed position, the stopper 23 can automatically return to the locked position. In this way, the first covering member 21 can be safely held at the closed position.

### OTHER EMBODIMENTS

While the present disclosure has been described herein with reference to specific embodiments, various kinds of changes, additions, or deletion may be possible, for example, but not limited to, related to their appearances or structures. For example, in the above-described embodiment, the hinge bodies 22c may be free stop hinges. However, the hinge bodies 22c may be other types of hinges configured to have a smaller rotational friction applied thereto.

In the embodiment described above, the first hinge frame 22a and the second hinge frame 22b are provided. However, either the first hinge frame 22a or the second hinge frame 22b may be not provided. Instead, the hinge bodies 22c and the stopper 23 may be directly fixed to the first covering member 21 and/or the housing 2d. If the first hinge frame 22a is not provided, the covering member detection switch 27 can be directly operated by the first covering member 21.

In the embodiment described above, the stopper 23 is biased by gravity. However, the stopper 23 may be biased by a spring force, a magnetic force, or a fluid pressure, etc. toward the lock position, when the covering member 21 is at the closed position.

What is claimed is:

1. A cover device of a noodle-making machine, comprising:
a covering member configured to cover an opening where a cutting blade used for shredding a noodle band can be exchanged therethrough;
a hinge member configured to support the covering member so that the covering member is moved between an open position, where the opening is exposed, and a closed position, where the opening is covered; and
a stopper configured to prevent the covering member from moving to the open position when the covering member is positioned at the closed position, wherein:
the stopper is provided at a first surface of the covering member, the first surface being on a side opposite to a second surface of the covering member configured to face the opening,
when the covering member is at the closed position, the stopper is configure to extend across a covering member side portion of the hinge member and a housing side portion of the hinge member, while a hinge shaft of the hinge member is positioned therebetween,
the stopper is configured to move between a locked position and an unlocked position along the covering member side portion and/or the housing side portion,
when the stopper is at the locked position, the stopper is configured to prevent the covering member from moving from the closed position to the open position,
when the stopper is at the unlocked position, the stopper allows the covering member to move from the closed position to the open position,
the stopper is biased so that the stopper moves from the unlocked position to the locked position, without operation by a user, when the covering member is at the closed position, and
the stopper is held between the covering member side portion and the housing side portion of the hinge member when the covering member is at the open position.

2. The cover device according to claim 1, wherein:
the hinge member is provided at an upper end portion of the covering member or at a lower end portion of the covering member, the hinge member being in a state that the hinge shaft extends horizontally,
the stopper is supported so as to rotate along the covering member side portion and/or the housing side portion of the hinge member, and
the stopper is configured to move from the unlocked position to the locked position under its own weight.

3. The cover device according to claim 2, wherein:
the hinge member is a free stop hinge providing frictional force against an opening and closing movement of the covering member, so that the covering member can be stopped at an optional orientation.

4. The cover device according to claim 2, wherein:
the stopper is an L-shaped angle member comprising a first plate portion and a second plate portion,
the first plate portion is supported by the covering member side portion or the housing side portion of the hinge member, located on one side opposite to a direction of gravity, so that the first plate portion can be freely rotate.

5. The cover device according to claim 1, further comprising:
a covering member detection switch configured to detect an opened or closed state of the covering member; and
a cutter configured to evenly cut the noodles, which were shredded by the cutting blade, into a predetermined length, wherein:
the covering member detection switch is disposed an area of the housing such that when the covering member is closed, the area is covered by the covering member, and such that when the covering member is opened, the area is exposed, and
the covering member detection switch is configured to send a signal to stop operation of the cutting blade and the cutter after the covering member detection switch detects the opened state of the covering member.

6. A cover device of a noodle-making machine, comprising:
a covering member configured to cover an opening through which a cutting blade used for shredding a noodle band can be exchanged;
a hinge member configured to support the covering member so that the covering member rotate about an axis of the hinge member between an open position, where the opening is exposed, and a closed position, where the opening is covered; and
a stopper configured to move between a locked position, in which the covering member is prevented from moving from the closed position to the open position, and an unlocked position, in which the covering member is not prevented from moving from the closed position to the open position, wherein:
the stopper is provided outside the opening,
when the covering member is at the closed position, the stopper is positioned to traverse the axis of the hinge member,
when the covering member is at the open position, the stopper is configured to traverse the axis of the hinge member.

7. The cover device according to claim 6, wherein the stopper is configured to rotate about an axis above, in a direction of gravity, the axis of the hinge member between the locked and unlocked positions.

8. The cover device according to claim 6, wherein the stopper is configured to move from the unlocked position to the locked position while the covering member moves from the open position to the closed position.

9. The cover device according to claim 6, wherein the stopper is configured to traverse the axis of the hinge member in a direction of gravity.

10. The cover device according to claim 6, wherein the stopper is configured to move from the unlocked position to the locked position due to gravity.

11. The cover device according to claim 6, wherein the axis of the hinge member is below the covering member in a direction of gravity.

12. The cover device according to claim 6, wherein the stopper is biased toward the locked position.

13. The cover device according to claim 6, wherein the stopper is configured to be positioned entirely above the axis of the hinge member when the stopper is in the unlocked position and the covering member is in the closed position.

14. The cover device according to claim 6, further comprising a covering member detection switch configured to detect an opened or closed state of the covering member, wherein the covering member detection switch is positioned above, in a direction of gravity, the axis of the hinge member.
